(19) United States
(12) Patent Application Publication
(10) Pub. No.: US 2020/0010605 A1
(43) Pub. Date: Jan. 9, 2020

(54) SOLUTION FOR FORMING SURFACE PROTECTIVE RESIN MEMBER, SOLUTION SET FOR FORMING SURFACE PROTECTIVE RESIN MEMBER, AND SURFACE PROTECTIVE RESIN MEMBER

(71) Applicant: FUJI XEROX CO., LTD., Tokyo (JP)

(72) Inventor: Hisae YOSHIZAWA, Minamiashigara-shi (JP)

(73) Assignee: FUJI XEROX CO., LTD., Tokyo (JP)

(21) Appl. No.: 16/150,676

(22) Filed: Oct. 3, 2018

(30) Foreign Application Priority Data
Jul. 4, 2018 (JP) 2018-127857

(51) Int. Cl. C08G 18/48; C08G 18/71; C08G 18/08; C08G 18/81; G02B 1/14

(52) U.S. Cl. CPC C08G 18/4837; C08G 18/718; G02B 1/14; C08G 18/8175; C08G 18/0842

(57) ABSTRACT

Provided is a solution for forming a surface protective resin member. The solution contains: an acrylic resin selected from: (i) an acrylic resin having a hydroxyl value of 40 to 280 and having a structure in which a silane coupling agent (a) having a functional group reactive with a hydroxyl group is bonded to a side chain; or (ii) an acrylic resin having a hydroxyl value of 40 to 280 and having a structure in which a silane coupling agent (b) having a vinyl group is polymerized as a monomer; and a polyol that has hydroxyl groups that are linked by a chain having 6 or more carbon atoms.

### CROSS-REFERENCE TO RELATED APPLICATIONS

This application is based on and claims priority under 35 USC 119 from Japanese Patent Application No. 2018-127857 filed on Jul. 4, 2018.

### BACKGROUND

### Technical Field

The present invention relates to a solution for forming a surface protective resin member, a solution set for forming a surface protective resin member, and a surface protective resin member.

### Related Art

Conventionally, in various fields, from the viewpoint of suppressing scratches on the surface, a surface protective resin member such as a surface protective film is provided. Examples of applications of the surface protective resin member include protective films for protecting screens and bodies other than screens in portable devices such as mobile phones and portable game machines, car bodies and door handles, an exterior of a piano, various members (for example, an intermediate transfer member) of an image forming device, or the like.

For example, JP-A-2000-119590 discloses “a curable resin composition for a topcoat paint, composed of: 100 parts by weight of a resin (A) component; 0 to 200 parts by weight of a silicone compound represented by General Formula (1):

(R¹O)₄₋ₐ—Si—R²ₐ (1)

(in the formula, R¹ is a monovalent hydrocarbon group selected from an alkyl group having 1 to 10 carbon atoms, an aryl group having 6 to 10 carbon atoms and an aralkyl group having 7 to 10 carbon atoms, R² is a monovalent hydrocarbon group selected from an alkyl group having 1 to 10 carbon atoms, an aryl group having 6 to 10 carbon atoms and an aralkyl group having 7 to 10 carbon atoms, and a represents 0 or 1) and/or a partially hydrolyzed condensate (B) thereof; 0.1 to 30 parts by weight of a compound (C) component containing two or more isocyanate groups, as a crosslinking agent; 0 to 30 parts by weight of an organometallic compound (D) component; and 0.1 to 100 parts by weight of a mono-functional isocyanate compound (E) component”.

In addition, JP-A-2002-129097 discloses “a curable resin composition for a paint, composed of: an acrylic resin (A) component containing a hydroxyl group; a vinyl-based copolymer (B) component containing a silyl group bonded to a hydrolyzable group; a polyfunctional isocyanate compound (C) component; and a weak solvent (D) component”.

Further, JP-A-2014-037454 discloses “a two-part curable coating agent, containing a main agent, and 3 to 100 parts by weight of a curing agent containing a polyisocyanate, the main agent containing or being obtained by reacting 100 parts by weight of an acrylic polymer having a photopolymerizable group and a hydroxyl group in its side chain and having a hydroxyl value of 30 mgKOH/g to 350 mgKOH/g and a weight average molecular weight of 5000 to 200000; 0.3 to 35 parts by weight of a silane coupling agent; 0.3 to 35 parts by weight of a polyether polyol; 3 to 70 parts by weight of a polylactone polyol; and 6 to 500 parts by weight of a photopolymerizable polyfunctional compound having two or more photopolymerizable groups in one molecule”.

### SUMMARY

Aspects of non-limiting embodiments of the present disclosure relate to provide a solution for forming a surface protective resin member, which is capable of forming a surface protective resin member having a self-repairing property and a low friction coefficient, compared with a case where an acrylic resin contained in a solution for forming a surface protective resin member does not have a structure in which a silane coupling agent having a functional group reactive to a hydroxyl group is bonded to a side chain, or does not have a structure in which a silane coupling agent having a vinyl group is polymerized as a monomer.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the invention, there is provided a solution for forming a surface protective resin member, the solution comprising: an acrylic resin selected from: (i) an acrylic resin having a hydroxyl value of 40 to 280 and having a structure in which a silane coupling agent (a) having a functional group reactive with a hydroxyl group is bonded to a side chain; or (ii) an acrylic resin having a hydroxyl value of 40 to 280 and having a structure in which a silane coupling agent (b) having a vinyl group is polymerized as a monomer; and a polyol that has a plurality of hydroxyl groups that are linked by a chain having 6 or more carbon atoms.

### DETAILED DESCRIPTION

Exemplary Embodiments of the present invention will be described below with reference to two preferred embodiments ([First Embodiment] and [Second Embodiment]). Each of the above two embodiments may be also referred to as “the exemplary embodiment”.

The exemplary embodiment is one example of implementing the present invention, and the present invention is not limited to the following embodiments.

### <Solution for Forming Surface Protective Resin Member>

### First Embodiment

A solution for forming a surface protective resin member of the first embodiment contains: an acrylic resin that has a hydroxyl value of 40 to 280 and that has a structure in which a silane coupling agent (a) having a functional group reactive with a hydroxyl group is bonded to a side chain; and a polyol that has a plurality of hydroxyl groups linked by a chain having 6 or more carbon atoms.

### Second Embodiment

A solution for forming a surface protective resin member of the second embodiment contains: an acrylic resin that has a hydroxyl value of 40 to 280 and that has a structure in which a silane coupling agent (b) having a vinyl group (CH₂═C(—R³¹)—, wherein R³¹ represents a hydrogen atom or an alkyl group having 1 to 4 carbon atoms.) is polymerized as a monomer; and a polyol that has a plurality of hydroxyl groups linked by a chain having 6 or more carbon atoms.

In the present specification, the unit of the hydroxyl value is “mgKOH/g”, but this unit may be omitted.

The solution for forming a surface protective resin member according to the exemplary embodiment is mixed with a solution containing a polyfunctional isocyanate and cured to be used, that is, the solution is used as a material for forming a surface protective resin member containing a polyurethane resin. Since the solution for forming a surface protective resin member according to the exemplary embodiment contains the above configuration, a surface protective resin member having a self-repairing property and a low friction coefficient can be formed.

The reasons for this are presumed as follows.

The resin to be synthesized when the solution for forming a surface protective resin member according to the exemplary embodiment (hereinafter simply referred to as “A solution”) and the solution containing a polyfunctional isocyanate (hereinafter simply referred to as “B solution”) are mixed and cured will be described.

Hereinafter, an acrylic resin that has a structure in which a silane coupling agent (a) having a functional group reactive with a hydroxyl group is bonded to a side chain, or a structure in which a silane coupling agent (b) having a vinyl group (CH₂═C(—R³¹)—, wherein R³¹ represents a hydrogen atom or an alkyl group having 1 to 4 carbon atoms.) is referred to as “specific acrylic resin (X)” or simply “(X)”. Hereinafter, a polyol that has a plurality of hydroxyl groups linked by a chain having 6 or more carbon atoms is referred to as “long-chain polyol (Y)” or simply “(Y)”. In a case where the “A solution” containing specific acrylic resin (X) and long-chain polyol (Y), and the B solution containing a polyfunctional isocyanate (Z) are mixed and cured, the OH group of the (X) and the OH group of the (Y) react with the polyfunctional isocyanate (Z) to form urethane bonds.

Therefore, a structure is obtained in which a plurality of specific acrylic resins (X) are urethane-bonded to the polyfunctional isocyanate (Z) and the polyfunctional isocyanate (Z) is urethane-bonded to the long-chain polyol (Y), that is, a structure is formed in which the specific acrylic resins (X) are crosslinked via the long-chain polyol (Y) and the polyfunctional isocyanate (Z).

Accordingly, the specific acrylic resins (X) form a crosslinked structure via the long-chain polyol (Y) and the polyfunctional isocyanate (Z), and thereby the formed surface protective resin member is considered to exert a self-repairing property.

In addition, a siloxane unit is introduced in the specific acrylic resin (X) by reacting the silane coupling agent (a) having a functional group reactive with a hydroxyl group, or polymerizing the silane coupling agent (b) having a vinyl group (CH₂═C(—R³¹)—, wherein R³¹ represents a hydrogen atom or an alkyl group having 1 to 4 carbon atoms.) as a monomer. The siloxane unit is considered to be introduced into the side chain of the specific acrylic resin (X) and easily appear on the surface of the formed surface protective resin member, and thereby the friction coefficient of the surface protective resin member is reduced.

In the exemplary embodiment, a surface protective resin member having a self-repairing property and a low friction coefficient is thus formed.

Next, each component constituting the solution (A solution) for forming a surface protective resin member according to the exemplary embodiment will be described in detail.

### (Acrylic Resin)

Examples of the acrylic resin of the exemplary embodiment include the specific acrylic resin of the following two embodiments.

### First Embodiment

A specific acrylic resin having a structure in which the silane coupling agent (a) having a functional group reactive with a hydroxyl group is bonded to a side chain is used as the specific acrylic resin of the first embodiment.

### Second Embodiment

A specific acrylic resin having a structure in which the silane coupling agent (b) having a vinyl group (CH₂═C(—R³¹)—, wherein R³¹ represents a hydrogen atom or an alkyl group having 1 to 4 carbon atoms.) is polymerized as a monomer is used as the specific acrylic resin of the second embodiment.

It is more preferable that the specific acrylic resin of the first embodiment further has a structure in which the silane coupling agent (b) having a vinyl group (CH₂═C(—R³¹)—, wherein R³¹ represents a hydrogen atom or an alkyl group having 1 to 4 carbon atoms.) is polymerized as a monomer.

The specific acrylic resin of the exemplary embodiment has a hydroxyl value of 40 mgKOH/g to 280 mgKOH/g.

The specific acrylic resin having a hydroxyl group includes those having a carboxy group in addition to those having a hydroxyl group in the molecular structure.

The hydroxyl group is introduced, for example, by using a monomer having a hydroxyl group as a monomer to be a raw material of the specific acrylic resin. Examples of the monomer having a hydroxyl group include (1) an ethylenic monomer having a hydroxy group, such as hydroxymethyl (meth)acrylate, hydroxyethyl (meth)acrylate, hydroxypropyl (meth)acrylate, hydroxybutyl (meth)acrylate, and N-methylolacrylamine.

In addition, (2) an ethylenic monomer having a carboxy group, such as (meth)acrylic acid, crotonic acid, itaconic acid, fumaric acid, and maleic acid may be used.

Further, a monomer not having a hydroxyl group may be used in combination with the monomer to be a raw material of the specific acrylic resin. Examples of the monomer not having a hydroxyl group include an ethylenic monomer copolymerizable with the monomers (1) and (2), for example, alkyl (meth)acrylates such as methyl (meth)acrylate, ethyl (meth)acrylate, propyl (meth)acrylate, butyl (meth)acrylate, n-propyl (meth)acrylate, isobutyl (meth)acrylate, 2-ethylhexyl (meth)acrylate, n-octyl (meth)acrylate and n-dodecyl (meth)acrylate.

From a viewpoint of compatibility, the weight average molecular weight of the specific acrylic resin is preferably 10000 to 80000, and more preferably 15000 to 30000.

The weight average molecular weight of the specific acrylic resin is measured by gel permeation chromatography (GPC). The measurement of the molecular weight by GPC is performed with a THF solvent using GPC⋅HLC-8120 GPC manufactured by Tosoh Corporation as a measuring apparatus, and using a Column⋅TSK gel Super HM-M (15 cm) manufactured by Tosoh Corporation. The weight average molecular weight and the number average molecular weight are calculated from this measurement result using a molecular weight calibration curve prepared from a monodisperse polystyrene standard sample.

In the present specification, the term “(meth) acrylic acid” is a concept encompassing both acrylic acid and methacrylic acid.

### Fluorine Atom

It is preferable that the specific acrylic resin contains a fluorine atom in the molecule structure. Since the specific acrylic resin contains the fluorine atom, a surface protective resin member can be easily formed, which maintains a self-repairing property, and has a low friction coefficient and excellent oil repellency.

The fluorine atom is introduced, for example, by using a monomer having a fluorine atom as a monomer to be a raw material of the specific acrylic resin. Examples of the monomer having a fluorine atom include 2-(perfluorobutyl)ethyl acrylate, 2-(perfluorobutyl)ethyl methacrylate, 2-(perfluorohexyl)ethyl acrylate, 2-(perfluorohexyl)ethyl methacrylate, perfluorohexylethylene, hexafluoropropene, hexafluoropropene epoxide, perfluoro(propyl vinyl ether) or the like.

The fluorine atom is preferably contained in the side chain of the specific acrylic resin from a viewpoint of obtaining a surface protective member which maintains a self-repairing property and has a low friction coefficient and excellent oil repellency. The number of carbon atoms in the side chain containing a fluorine atom is, for example, 2 to 20. In addition, the carbon chain in the side chain containing a fluorine atom may be a linear or branched chain.

The number of fluorine atoms contained in one molecule of the monomer containing a fluorine atom is not particularly limited, and is preferably 1 to 25, and more preferably 3 to 17.

The proportion of the fluorine atom to the whole specific acrylic resin is preferably 0.1 mass % to 30 mass %, and more preferably 1 mass % to 20 mass %.

### (Silane Coupling Agent)

The specific acrylic resin has a structure derived from a silane coupling agent in the molecular structure thereof. Since the specific acrylic resin has the structure derived from the silane coupling agent, a surface protective resin member having a low friction coefficient can be easily formed.

The structure derived from the silane coupling agent in the specific acrylic resin according to the first embodiment is introduced by using the silane coupling agent (a) having a functional group reactive with a hydroxyl group as a raw material of the specific acrylic resin. A moiety having a silicon atom in the silane coupling agent (a) is introduced into the side chain of the specific acrylic resin by using the silane coupling agent (a) having a functional group reactive with a hydroxyl group. Accordingly, the moiety having a silicon atom is easy to be exposed on the surface of the surface protective resin member, and the friction coefficient of the surface protective resin member is lowered.

Examples of the functional group reactive with a hydroxyl group include an isocyanate group (—NCO), an epoxy group, an amino group, or the like.

Among these, an isocyanate group is preferred.

It is preferable that the number of the functional group of the silane coupling agent having a functional group reactive with a hydroxyl group (hereinafter, also referred to as “hydroxyl group-reactive silane coupling agent”) is only one in one molecular structure. Since there is only one functional group, in the side chain into which the moiety having a silicon atom is introduced, the terminal side thereof (the side opposite to the side bonded to the main chain of the acrylic resin) is not fixed. Therefore, the easiness of movement of the side chain is further improved, the moiety having a silicon atom is more easily exposed on the surface of the surface protective resin member and the friction coefficient of the surface protective resin member is lowered.

Examples of the hydroxyl group-reactive silane coupling agent include a compound having a structure represented by the following General Formula (S2).

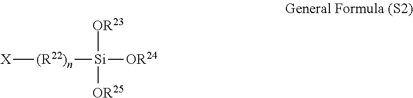

(In General Formula (S2), X represents a functional group reactive with a hydroxyl group, R²² represents a divalent organic group, R²³, R²⁴ and R²⁵ each independently represents a hydrogen atom or an alkyl group having 1 to 4 carbon atoms, and n represents 0 or 1.)

Examples of the organic group represented by R²² include a group containing at least one atom selected from the group of atoms consisting of C, H, O and N. For example, a group such as a divalent hydrocarbon group which may have a hetero atom (for example, an alkylene group), —O—, —C(═O)— and —C(═O)—O—, or a group formed by combining two or more of these groups.

R²² is preferably a divalent hydrocarbon group which may have a hetero atom (more preferably an alkylene group, and still more preferably an alkylene group having 1 to 4 carbon atoms). Among these, an ethylene group and n-propylene group are more preferred.

In addition, n is preferably 1.

The alkyl group represented by R²³, R²⁴ and R²⁵ may be linear or branched. Examples of the alkyl group include a methyl group, an ethyl group or the like.

R²³, R²⁴ and R²⁵ may be each independently a hydrogen atom, a methyl group, or an ethyl group.

Examples of the hydroxyl group-reactive silane coupling agent include trimethoxysilylpropyl isocyanate, triethoxysilylpropyl isocyanate, trimethoxysilylethyl isocyanate, triethoxysilylethyl isocyanate, 3-glycidoxypropylmethyldimethoxysilane, 3-glycidoxypropyltrimethoxysilane, 3-glycidoxypropyltriethoxysilane, 3-aminopropyltriethoxysilane, 3-aminopropyltrimethoxysilane, N-2-(aminoethyl)-3-aminopropyltrimethoxysilane, or the like.

Among these, trimethoxysilylpropyl isocyanate and triethoxysilylpropyl isocyanate are preferred.

The structure derived from the silane coupling agent in the specific acrylic resin according to the second embodiment is introduced, for example, by using the silane coupling agent (b) as a monomer to be a raw material of the specific acrylic resin, that is, using the silane coupling agent (b) having a vinyl group (CH₂═C(—R¹¹)—, wherein R¹¹ represents a hydrogen atom or an alkyl group having 1 to 4 carbon atoms.) as a monomer. A moiety having a silicon atom in the silane coupling agent (b) is introduced into the side chain of the specific acrylic resin by using the silane coupling agent (b) having a vinyl group as a monomer. Accordingly, the moiety having a silicon atom is easy to be exposed on the surface of the surface protective resin member, and the friction coefficient of the surface protective resin member is lowered.

Examples of the silane coupling agent (b) having a vinyl group include a compound having a structure represented by the following General Formula (S1).

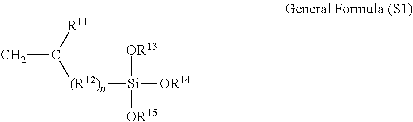

(In General Formula (S1), R¹¹ represents a hydrogen atom or an alkyl group having 1 to 4 carbon atoms, R¹² represents a divalent organic group, R¹³, R¹⁴ and R¹⁵ each independently represents a hydrogen atom or an alkyl group having 1 to 4 carbon atoms, and n represents 0 or 1.)

The alkyl group represented by R¹¹ may be linear or branched. Examples of the alkyl group include a methyl group, an ethyl group, an isobutyl group or the like.

R¹¹ is preferably a hydrogen atom or a methyl group.

Examples of the organic group represented by R¹² include a group containing at least one atom selected from the group of atoms consisting of C, H, O and N. For example, a group such as a divalent hydrocarbon group which may have a hetero atom (for example, an alkylene group), —O—, —C(═O)— and —C(═O)—O—, or a group formed by combining two or more of these groups.

R¹² may be a group composed of a combination of: a group selected from any one of —O—, —C(═O)— and —C(═O)—O— (preferably —C(═O)—O—); and a divalent hydrocarbon group which may have a hetero atom (preferably an alkylene group, and more preferably an alkylene group having 1 to 5 carbon atoms). Among these, —COO—(CH₂)₃— and —COO—(CH₂)₂— are more preferred.

In addition, n is preferably 1.

The alkyl group represented by R¹³, R¹⁴, and R⁵ may be linear or branched and includes, for example, the same group as the alkyl group represented by R¹.

R¹³, R¹⁴ and R¹⁵ may be each independently a hydrogen atom, a methyl group, or an ethyl group.

Examples of the silane coupling agent having a vinyl group include trimethoxysilylpropyl (meth)acrylate, triethoxysilylpropyl (meth)acrylate, trimethoxysilylethyl (meth)acrylate, triethoxysilylethyl (meth)acrylate, 3-methacryloxypropylmethyldimethoxysilane, 3-methacryloxypropylmethyl diethoxysilane, or the like.

Among these, trimethoxysilylpropyl (meth)acrylate and triethoxysilylpropyl (meth)acrylate are preferred.

In a case are the structure derived from the silane coupling agent is introduced into a urethane resin by using at least one of the silane coupling agent having a vinyl group and the hydroxyl group-reactive silane coupling agent, the proportion of the silicon atom (Si) is preferably 0.05 mass % to 1 mass %, and more preferably 0.1 mass % to 0.5 mass %, with respect to the entire urethane resin.

### Hydroxyl Value

The specific acrylic resin has a hydroxyl value of 40 mgKOH/g to 280 mgKOH/g. The hydroxyl value is preferably 70 mgKOH/g to 210 mgKOH/g.

When the hydroxyl value is 40 mgKOH/g or more, a polyurethane resin having a high crosslinking density is polymerized, and when the hydroxyl value is 280 mgKOH/g or less, a polyurethane resin having moderate flexibility can be obtained.

The hydroxyl value of the specific acrylic resin is adjusted by the proportion of the monomer having a hydroxyl group in all the monomers synthesizing the specific acrylic resin.

The hydroxyl value represents the mass of potassium hydroxide in milligrams required for acetylating the hydroxyl group in 1 g of the sample. The hydroxyl value in the exemplary embodiment is measured according to the method defined in JIS K 0070-1992 (potentiometric titration method). However, when the sample does not dissolve, a solvent such as dioxane or tetrahydrofuran (THF) is used.

The synthesis of the specific acrylic resin is performed, for example, by mixing the above-mentioned monomers, and performing ordinary radical polymerization, ionic polymerization or the like, and followed by purification.

### (Polyol)

The polyol (hereinafter referred to as “long-chain polyol”) is a polyol having a plurality of hydroxyl groups linked to each other by a chain having 6 or more carbon atoms (the number of carbon atoms in the straight chain portion linking the hydroxyl groups).

A flexible resin can be obtained by linking all the hydroxyl groups to each other by the chain having 6 or more carbon atoms (the number of carbon atoms in the straight chain portion linking the hydroxyl groups).

The number of functional groups in the long-chain polyol (that is, the number of hydroxyl groups contained in one molecule of the long-chain polyol) may be, for example, in a range of 2 to 5, or may be in a range of 2 to 3.

The chain having 6 or more carbon atoms in the long-chain polyol represents a chain whose number of carbon atoms in the straight chain portion linking the hydroxyl groups is 6 or more. Examples of the chain having 6 or more carbon atoms include an alkylene group or a divalent group formed by combining one or more of alkylene groups with one or more groups selected from —O—, —C(═O)— and —C(═O)—O—. It is preferable that the long-chain polyol having hydroxyl groups linked to each other by the chain having 6 or more carbon atoms has a structure of —[CO(CH₂)ₙ₁O]₂—H. Here, n1 represents 1 to 10, preferably 3 to 6, and more preferably 5. n2 represents 1 to 50, preferably 1 to 10.

Examples of the long-chain polyol include a bifunctional polycaprolactone diol, a trifunctional polycaprolactone triol, a tetrafunctional or higher functional polycaprolactone polyol or the like.

Examples of the bifunctional polycaprolactone diol include a compound having two groups each having a hydroxyl group in a terminal. The group having a hydroxyl group in a terminal is represented by —[CO(CH₂)ₙ₁₁O]n₁₂—H. Here, n11 represents 1 to 10, preferably 3 to 6, and more preferably 5. n12 represents 1 to 50, preferably 1 to 10. Among these, the compound represented by the following General Formula (1) is preferred.

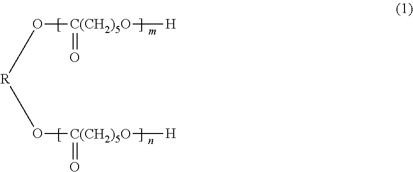

In General Formula (1), R represents an alkylene group or a divalent group formed by combining an alkylene group and one or more groups selected from —O— and —C(═O)—; and m and n each independently represents an integer of 1 to 35.

In General Formula (1), the alkylene group contained in the divalent group represented by R may be linear or branched. The alkylene group is preferably an alkylene group having 1 to 10 carbon atoms, and more preferably an alkylene group having 1 to 5 carbon atoms.

The divalent group represented by R is preferably a linear or branched alkylene group having 1 to 10 carbon atoms (preferably 2 to 5 carbon atoms), or preferably a group formed by linking two linear or branched alkylene groups having 1 to 5 carbon atoms (preferably 1 to 3 carbon atoms) with —O— or —C(═O)— (preferably —O—). Among these, the divalent group represented by *—C₂H₄—*, *—C₂H₄OC₂H₄—*, or *—C(CH₃)₂—(CH₂)₂—* is more preferred. The divalent groups listed above are bonded at the “*” part, respectively.

m and n each independently represent an integer of 1 to 35, and preferably 2 to 5.

Examples of the trifunctional polycaprolactone diol include a compound having three groups each having a hydroxyl group in the terminal. The group having a hydroxyl group in a terminal is represented by —[CO(CH₂)ₙ₂₁O]ₙ₂₂—H. Here, n21 represents 1 to 10, preferably 3 to 6, and more preferably 5, and n22 represents 1 to 50, preferably 1 to 28. Among these, the compound represented by the following General Formula (2) is preferred.

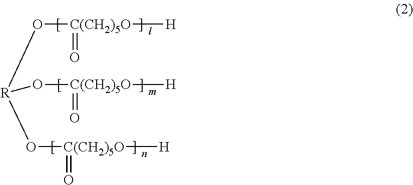

In General Formula (2), R represents a trivalent group formed by removing one hydrogen atom from an alkylene group, or a trivalent group formed by combining a trivalent group formed by removing one hydrogen atom from an alkylene group and one or more groups selected from an alkylene group, —O— and —C(═O)—. l, m and n each independently represent an integer of 1 to 28, and l+m+n is 3 to 30.

In General Formula (2), in a case where R represents the trivalent group formed by removing one hydrogen atom from an alkylene group, the group may be linear or branched. The trivalent group formed by removing one hydrogen atom from an alkylene group is preferably an alkylene group having 1 to 10 carbon atoms, and more preferably an alkylene group having 1 to 6 carbon atoms.

The R may be a trivalent group formed by combing the trivalent group formed by removing one hydrogen atom from an alkylene group shown above and one or more groups selected from an alkylene group (for example, an alkylene group having 1 to 10 carbon atoms), —O— and —C(═O)—.

The trivalent group represented by R is preferably a trivalent group formed by removing one hydrogen atom from a linear or branched alkylene group having 1 to 10 carbon atoms (preferably 3 to 6 carbon atoms). Among these, the trivalent group represented by *—CH₂—CH(—*)—CH₂—*, CH₃—C(—*)(—*)—(CH₂)₂—*, and CH₃CH₂C(—*)(—*)(CH₂)₃—* can be mentioned. The trivalent groups listed above are bonded at the “*” part, respectively.

l, m and n each independently represent an integer of 1 to 28, and preferably 1 to 5. l+m+n is 3 to 30, and preferably 3 to 15.

A long-chain polyol containing a fluorine atom may be used as the long-chain polyol.

Examples of the long-chain polyol containing a fluorine atom include a long-chain diol having 6 to 12 carbon atoms (for example, a diol in which two hydroxyl groups are bonded with an alkylene group having 6 to 12 carbon atoms) in which part or all of H atoms bonded to the carbon atoms are replaced by fluorine atoms in which part or all of H atoms bonded to the carbon atoms are replaced by fluorine atoms, a long-chain glycol having 6 to 12 carbon atoms, such as a polyolefin glycol having 6 to 12 carbon atoms which is obtained by polymerizing a plurality of olefin glycols such as ethylene glycol and propylene glycol, in which part or all of H atoms bonded to the carbon atoms are replaced with fluorine atoms, or the like. Specifically, 1H,1H,9H,9H-perfluoro-1,9-nonanediol, fluorinated tetraethylene glycol, 1H,1H,8H,8H-perfluoro-1,8-octanediol or the like can be mentioned.

The long-chain polyol may be used alone only, or may be used in combination of two or more thereof.

The addition amount of the long-chain polyol with respect to the specific acrylic resin may be adjusted such that a molar ratio [OH_{B}]/[OH_{A}] of a content (total molar amount) [OH_{B}] of the hydroxyl group contained in the long-chain polyol to a content (total molar amount) [OH_{A}] of all the hydroxyl groups contained in the specific acrylic resin in a range of 0.1 to 10, and the range may be 0.1 to 4.

The long-chain polyol preferably has a hydroxyl value of 30 mgKOH/g to 300 mgKOH/g, and more preferably 50 mgKOH/g to 250 mgKOH/g. It is inferred that when the hydroxyl value is 30 mgKOH/g or more, a polyurethane resin having a high crosslinking density is polymerized, and when the hydroxyl value is 300 mgKOH/g or less, a polyurethane resin having moderate flexibility can be obtained.

The above hydroxyl value represents the mass of potassium hydroxide in milligrams required for acetylating the hydroxyl group in 1 g of the sample. The above hydroxyl value in the exemplary embodiment is measured according to the method defined in JIS K 0070-1992 (potentiometric titration method). However, when the sample does not dissolve, a solvent such as dioxane or THF is used.

### (Ratio of Silicon Atom to Fluorine Atom)

In the solution (A solution) for forming a surface protective resin member according to the exemplary embodiment, the specific acrylic resin has a structure derived from the silane coupling agent in the molecular structure (for example, at least one of the structure in which the silane coupling agent having a functional group reactive with a hydroxyl group is bonded to a side chain, and the structure in which the silane coupling agent having a vinyl group is polymerized as a monomer), and the specific acrylic resin may further contain a fluorine atom.

In this case, a ratio (mass ratio) of each of an amount [F₁] of the fluorine atom and an amount [Si₂] of the silicon atom with respect to a total of the [F₁] and the [Si₂] contained in the specific acrylic resin is preferably in the following range.

The mass ratio [F₁]/([F₁]+[Si₂]) is preferably 0.5 to 0.95, and more preferably 0.7 to 0.95.

When the mass ratio [F₁]/([F₁]+[Si₂]) is within the above range, it is preferable in that the friction coefficient can be lowered while maintaining the oil repellency.

The mass ratio [Si₂]/([F₁]+[Si₂]) is preferably 0.05 to 0.4, and more preferably 0.1 to 0.2.

When the mass ratio [Si₂]/([F₁]+[Si₂]) is within the above range, it is preferable in that the friction coefficient can be lowered while maintaining the oil repellency.

### <Solution Set for Forming Surface Protective Resin Member>

The solution set for forming a surface protective resin member according to the exemplary embodiment contains a first solution containing the solution (A solution) for forming a surface protective resin member according to the exemplary embodiment as described above, and a second solution (B solution) containing a polyfunctional isocyanate.

### (Polyfunctional Isocyanate)

The polyfunctional isocyanate reacts with, for example, the hydroxyl group of the specific acrylic resin, the hydroxyl group of the long-chain polyol, or the like. In addition, the polyfunctional isocyanate functions as a crosslinking agent for crosslinking between specific acrylic resins, between the specific acrylic resin and the long-chain polyol, and between long-chain polyols.

Examples of the polyfunctional isocyanate are not particularly limited and include a bifunctional diisocyanate such as methylene diisocyanate, toluene diisocyanate, hexamethylene diisocyanate, and isophorone diisocyanate. In addition, a multimer of hexamethylene polyisocyanate having a burette structure, an isocyanurate structure, an adduct structure, an elastic structure, or the like may be also preferably used as a polyfunctional isocyanate.

Commercially available polyfunctional isocyanate may be used, for example, polyisocyanate (DURANATE) manufactured by Asahi Kasei Corporation may be used.

Only one type of the polyfunctional isocyanate may be used, or two or more types thereof may be used by mixing.

### (Other Additives)

In the exemplary embodiment, other additives in addition to the first solution (A solution) and the second solution (B solution) may be contained. Examples of the other additives include an antistatic agent, a reaction accelerator for accelerating the reaction between the hydroxyl groups (—OH) in the specific acrylic resin and in the long-chain polyol and the isocyanate groups (—NCO) in the polyfunctional isocyanate, or the like.

### Antistatic Agent

Specific examples of the antistatic agent include cationic surfactant compounds (e.g., a tetraalkylammonium salt, a trialkylbenzylammonium salt, an alkylamine hydrochloride, and an imidazolium salt), anionic surfactant compounds (e.g., an alkyl sulfonate, an alkyl benzene sulfonate, and an alkyl phosphate), nonionic surfactant compounds (e.g., glycerin fatty acid ester, polyoxyalkylene ether, polyoxyethylene alkyl phenyl ether, N,N-bis-2-hydroxyethylalkylamine, hydroxyalkyl monoethanolamine, polyoxyethylene alkylamine, fatty acid diethanolamide, and polyoxyethylene alkylamine fatty acid ester), amphoteric surfactant compounds (e.g., alkyl betaine and alkyl imidazolium betaine), or the like.

In addition, examples of the antistatic agent include those containing quaternary ammonium.

Specifically, examples include tri-n-butylmethyl ammonium bistrifluoromethanesulfonimide, lauryl trimethyl ammonium chloride, octyldimethyl ethyl ammonium ethyl sulphate, didecyl dimethyl ammonium chloride, lauryl dimethyl benzyl ammonium chloride, stearyl dimethyl hydroxyethyl ammonium para-toluene sulfonate, tributylbenzylammonium chloride, lauryldimethylaminoacetic acid betaine, lauric acid amidopropyl betaine, octanoic acid amidopropyl betaine, polyoxyethylene stearylamine hydrochloride, or the like. Among these, tri-n-butylmethylammonium bistrifluoromethanesulfonimide is preferred.

In addition, an antistatic agent having a high molecular weight may be used.

Examples of the antistatic agent having a high molecular weight include a polymer compound obtained by polymerizing acrylates containing a quaternary ammonium salt group, a polystyrene sulfonic acid-type polymer compound, a polycarboxylic acid-type polymer compound, a polyetherester-type polymer compound, an ethylene oxide-epichlorohydrin-type polymer compound, a polyetheresteramide-type polymer compound, or the like.

Examples of the polymer compound obtained by polymerizing a quaternary ammonium salt group-containing acrylate include a polymer compound having at least the following structural unit (A).

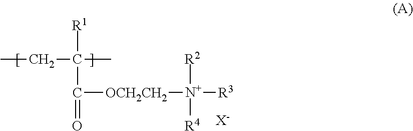

In structural unit (A), R¹ represents a hydrogen atom or a methyl group, R², R³ and R⁴ each independently represents an alkyl group, and X⁻ represents an anion.

The polymerization of the antistatic agent having a high molecular weight can be performed by a known method.

As the antistatic agent having a high molecular weight, only a polymer compound composed of the same monomers may be used, or two or more of polymer compounds composed of different monomers may be used in combination.

It is preferable to adjust the surface resistance of the surface protective resin member formed in the exemplary embodiment to be in the range of 1×10⁹Ω/□ to 1×10¹⁴Ω/□, and to adjust the volume resistance thereof to be in the range of 1×10⁸ Ωcm to 1×10¹³ Ωcm.

The surface resistance and the volume resistance are measured in accordance with JIS-K6911 under the environment of 22° C. and 55% RH using a HIRESTA UP MCP-450 UR probe manufactured by Dia Instruments Co., Ltd.

The surface resistance and the volume resistance of the surface protective resin member are controlled by adjusting the type, content, or the like of the antistatic agent as long as the antistatic agent is contained.

The antistatic agent may be used alone, or may be used in combination of two or more thereof.

### Reaction Accelerator

Examples of the reaction accelerator for accelerating the reaction between the hydroxyl groups (—OH) in the specific acrylic resin and in the long-chain polyol and the isocyanate groups (—NCO) in the polyfunctional isocyanate include a metal catalyst of tin or bismuth. Specifically, NEOSTAN U-28, U-50, U-600 and tin (II) stearate manufactured by NITTO KASEI Co., Ltd., can be mentioned. In addition, XC-C277 and XK-640 manufactured by Kusumoto Chemicals, Ltd. can be mentioned.

### (Content Ratio of Silane Coupling Agent)

As for the content ratio of the silane coupling agent of the exemplary embodiment, the content ratio of the following (i), (ii), or (iii) is preferably 0.2 mass % to 10 mass %, and more preferably 1 mass % to 5 mass %, with respect to the total amount of solid contents in the first solution and the second solution:

(i) the content ratio of the silane coupling agent (a) having a functional group reactive with a hydroxyl group in a case where the specific acrylic resin has only the structure in which the silane coupling agent (a) is bonded to a side chain as the structure derived from the silane coupling agent;

(ii) the content ratio of the silane coupling agent (b) having a vinyl group in a case where the specific acrylic resin has only the structure in which the silane coupling agent (b) is polymerized as a monomer as the structure derived from the silane coupling agent; and

(iii) the total content ration of the silane coupling agent (a) and the silane coupling agent (b) in a case where the specific acrylic resin has both of the structure in which the silane coupling agent (a) is bonded to a side chain, and the structure in which the silane coupling agent (b) is polymerized as a monomer, as the structure derived from the silane coupling agent.

When the content ratio of the silane coupling agent is 0.2 mass % or more, the friction coefficient of the surface protective resin member is easily reduced. When the content ratio of the silane coupling agent is 10 mass % or less, the self-repairing property of the surface protective member is easily maintained.

### <Surface Protective Resin Member>

The surface protective resin member according to the exemplary embodiment can be formed by mixing and curing the first solution (A solution) and the second solution (B solution) in the solution set for forming a surface protective resin member according to the above embodiment.

Not being limited to the case of using the first solution (A solution) and the second solution (B solution), the surface protective resin member can be formed by mixing and curing an acrylic resin (specific acrylic resin), a polyol (long-chain polyol) and a polyfunctional isocyanate. The specific acrylic resin has a hydroxyl value of 40 mgKOH/g to 280 mgKOH/g and has at least one structure of the structure in which the silane coupling agent (a) having a functional group reactive with a hydroxyl group is bonded to a side chain, and the structure in which the silane coupling agent (b) having a vinyl group (CH₂═C(—R³¹)—, wherein R³¹ represents a hydrogen atom or an alkyl group having 1 to 4 carbon atoms.) is polymerized as a monomer. The polyol (long-chain polyol) has a plurality of hydroxyl groups linked by a chain having 6 or more carbon atoms.

Here, a method of forming the surface protective resin member (a polymerization method of the resin) according to the exemplary embodiment will be described by giving a specific example.

For example, the A solution containing a specific acrylic resin and a long-chain polyol and the B solution containing a polyfunctional isocyanate are prepared. The A solution and the B solution are mixed, the mixed solution is defoamed under reduced pressure, and then the mixed solution is casted on a base material (for example, a polyimide film) to form a resin layer. Next, the mixed solution is heated (for example, at 85° C. for 60 minutes, and then at 160° C. for 0.5 hours) and cured to form the surface protective resin member.

However, in the exemplary embodiment, the method of forming the surface protective resin member is not limited to the above method. For example, in a case of using blocked polyfunctional isocyanate, it is preferable to cure by heating at a temperature at which the block is detached. Alternatively, the polymerization may be performed by methods of using ultrasonic waves instead of defoaming under reduced pressure, or allowing the mixed solution to stand for defoaming.

The thickness of the surface protective resin member is not particularly limited, and may be, for example, 1 μm to 100 μm, and may be 10 μm to 30 μm.

### Contact Angle

From a viewpoint of obtaining a surface protective resin member excellent in water repellency, the surface protective resin member according to the exemplary embodiment preferably has a contact angle with respect to water of 90° to 135°, and more preferably 100° to 135°.

From a viewpoint of obtaining a surface protective resin member excellent in oil repellency, the surface protective resin member according to the exemplary embodiment preferably has a contact angle with respect to hexadecane of 40° to 70°, and more preferably 50° to 65°.

The contact angle is adjusted by controlling the amount of the siloxane unit, the amount of the fluorine atom or the like contained in the specific acrylic resin and the long-chain polyol.

The contact angle is measured using a contact angle meter (model number: CA-X, manufactured by Kyowa Interface Science Co., Ltd.).

### Martens Hardness

The surface protective resin member according to the exemplary embodiment preferably has a Martens hardness at 23° C. of 0.5 N/mm² to 220 N/mm², and more preferably 1 N/mm² to 70 N/mm². When the Martens hardness at 23° C. is 0.5 N/mm² or more, the shape required for the resin member can be easily maintained. When the Martens hardness at 23° C. is 220 N/mm² or less, the ease of repairing a scratch (that is, self-repairing property) is easily improved.

### Return Rate

The surface protective resin member according to the exemplary embodiment preferably has a return rate at 23° C. of 70% to 100%, more preferably 80% to 100%, and even more preferably 90% to 100%. The return rate is an index indicating the self-repairing property of the resin material (the property of restoring the strain generated by the stress at the time of unloading the stress, that is, the degree of repairing a scratch). That is, when the return rate at 23° C. is 70% or more, the ease of repairing a scratch (that is, self-repairing property) is improved.

The Martens hardness and the return rate of the surface protective resin member are adjusted, for example, by controlling the hydroxyl value of the specific acrylic resin, the number of carbon atoms in the chain linking the hydroxyl groups in the long-chain polyol, the ratio of the long-chain polyol with respect to the specific acrylic resin, the number of functional groups (isocyanate groups) in the polyfunctional isocyanate, and the ratio of the polyfunctional isocyanate with respect to the specific acrylic resin.

The Martens hardness and the return rate is measured by using FISCHER SCOPE HM 2000 (manufactured by Fischer Instruments Co., Ltd.) as a measuring device, fixing a surface protective resin member (sample) to a slide glass with an adhesive and setting the two in the above measuring device. The surface protective resin member is loaded up to 0.5 mN for 15 seconds at a specific measurement temperature (23° C., for example), and held at 0.5 mN for 5 seconds. The maximum displacement at this time is set to be (h1). Thereafter, the load is reduced to 0.005 mN for 15 seconds, and held at 0.005 mN for 1 minute. The displacement when held at 0.005 mN for minute is set to be (h2). Then the return rate [(h1−h2)/h1] is calculated. From the load displacement curve during the loading, the Martens hardness can be obtained.

### [Application]

The surface protective resin member according to the exemplary embodiment can be used as a surface protective member for an object having a possibility of causing scratches on the surface due to contact with foreign matter, for example.

Specifically, the surface protective resin member can be applied in screens and bodies other than screens in portable devices (e.g., mobile phones, and portable game machines), screens of touch panels, building materials (e.g., flooring materials, tiles, wall materials, and wallpaper), automobile members (e.g., car interiors, car bodies, and door handles), storage containers (e.g., suitcases), cosmetic containers, eyeglasses (e.g., frames and lenses), sporting goods (e.g., golf clubs and rackets), writing utensils (e.g., fountain pens), musical instruments (e.g., an exterior of a piano), clothes storage tool (e.g., hanger), members for an image forming device such as a copying machine (e.g., a transfer member such as a transfer belt), leather goods (e.g., bags and school bags), decorative films, film mirrors, or the like.

### EXAMPLE

Hereinafter, the present invention will be described in more detail with reference to Examples and Comparative Examples, but the present invention is not limited to the following examples. In the following, “part” is on a mass basis unless otherwise specified particularly.

<Synthesis of Acrylic Resin Prepolymer a1>

Monomers of n-butyl methacrylate (nBMA), hydroxyethyl methacrylate (HEMA) and fluorine atom-containing acrylic monomer (FAMAC 6, manufactured by UNIMATEC CO., LTD.) are mixed in a molar ratio of 2.5:3:0.5. Further, a monomer solution is prepared by adding 2 mass % in proportion to monomers of a polymerization initiator (azobisisobutyronitrile (AIBN)) and 40 mass % in proportion to monomers of methyl ethyl ketone (MEK).

The monomer solution is charged into a dropping funnel and added dropwise to 50 mass % in proportion to monomers of MEK, heated to 80° C. under a nitrogen reflux, during stirring over 3 hours for polymerization. Further, a solution containing 10 mass % in proportion to monomers of MEK and 0.5 mass % in proportion to monomers of AIBN is added dropwise over 1 hour to complete the reaction. During the reaction, the temperature is kept at 80° C. and stirring is continued. Thus, an acrylic resin prepolymer precursor solution (solid content: 50 mass %) is synthesized.

The acrylic resin prepolymer a1 containing an acrylic resin having a structure in which a hydroxyl group-reactive silane coupling agent is bonded to a side chain is synthesized by mixing 0.57 part of a hydroxyl group-reactive silane coupling agent (KBE-9007, manufactured by Shin-Etsu Chemical Co., Ltd., 3-isocyanatepropyltriethoxysilane) with 4.0 parts of the acrylic resin prepolymer precursor solution and stirring the mixture at room temperature for 1 hour.

The hydroxyl value of the obtained acrylic resin prepolymer a1 is measured according to the method defined in JIS K 0070-1992, and as a result, the hydroxyl value is 165 mgKOH/g.

### (Potentiometric Titration Method)

In addition, a part of the obtained prepolymer a1 is separated by removing the solvent, and the obtained solid content is diluted to 0.1 mass % with tetrahydrofuran and subjected to GPC (Gel Permeation Chromatography), so as to measure the weight average molecular weight. As a result, the weight average molecular weight in terms of polystyrene is 17100.

<Synthesis of Acrylic Resin Prepolymer a2>

The acrylic resin prepolymer a2 containing an acrylic resin having a structure in which a hydroxyl group-reactive silane coupling agent is bonded to a side chain is obtained by being synthesized in the same manner as the acrylic resin prepolymer a1, except that 0.13 part of a hydroxyl group-reactive silane coupling agent (KBE-9007, manufactured by Shin-Etsu Chemical Co., Ltd., 3-isocyanatepropyltriethoxysilane) is mixed with 4.0 parts of the acrylic resin prepolymer precursor solution.

The hydroxyl value of the obtained acrylic resin prepolymer a2 is measured according to the method defined in JIS K 0070-1992 (potentiometric titration method), and as a result, the hydroxyl value is 169 mgKOH/g.

In addition, a part of the obtained prepolymer a2 is separated by removing the solvent, and the obtained solid content is diluted to 0.1 mass % with tetrahydrofuran and subjected to GPC (Gel Permeation Chromatography), so as to measure the weight average molecular weight. As a result, the weight average molecular weight in terms of polystyrene is 17600.

<Synthesis of Acrylic Resin Prepolymer a3>

Monomers of n-butyl methacrylate (nBMA), hydroxyethyl methacrylate (HEMA), fluorine atom-containing acrylic monomer (FAMAC 6, manufactured by UNIMATEC CO., LTD.), and trimethoxysilylpropyl (meth)acrylate (a silane coupling agent, KBM 503, manufactured by Shin-Etsu Chemical Co., Ltd.) are mixed in a molar ratio of 2.5:3:0.5:0.3. Further, a monomer solution is prepared by adding 2 mass % in proportion to monomers of a polymerization initiator (azobisisobutyronitrile (AIBN)) and 40 mass % in proportion to monomers of methyl ethyl ketone (MEK).

The monomer solution is charged into a dropping funnel and added dropwise to 50 mass % in proportion to monomers of MEK, heated to 80° C. under a nitrogen reflux, during stirring over 3 hours for polymerization. Further, a solution containing 0.5 mass % in proportion to monomers of MEK and 10 mass % in proportion to monomers of AIBN is added dropwise over 1 hour to complete the reaction. During the reaction, the temperature is kept at 80° C. and stirring is continued. Thus, an acrylic resin prepolymer a3 is synthesized.

The hydroxyl value of the obtained acrylic resin prepolymer a3 is measured according to the method defined in JIS K 0070-1992 (potentiometric titration method), and as a result, the hydroxyl value is 165 mgKOH/g.

In addition, a part of the obtained prepolymer a3 is separated by removing the solvent, and the obtained solid content is diluted to 0.1 mass % with tetrahydrofuran and subjected to GPC (Gel Permeation Chromatography), so as to measure the weight average molecular weight. As a result, the weight average molecular weight in terms of polystyrene is 18200.

<Synthesis of Acrylic Resin Prepolymer a4>

A precursor solution is prepared in the same manner as the acrylic resin prepolymer a1, except that monomers of n-butyl methacrylate (nBMA) and hydroxyethyl methacrylate (HEMA) are mixed in a molar ratio of 3:3.

The acrylic resin prepolymer a4 containing an acrylic resin having a structure in which a hydroxyl group-reactive silane coupling agent is bonded to a side chain is obtained by being synthesized in the same manner as the acrylic resin prepolymer a1, except that 0.13 part of a hydroxyl group-reactive silane coupling agent (KBE-9007, manufactured by Shin-Etsu Chemical Co., Ltd., 3-isocyanatepropyltriethoxysilane) is mixed with 4.0 parts of the precursor solution. The hydroxyl value of the obtained acrylic resin prepolymer a4 is measured according to the method defined in JIS K 0070-1992 (potentiometric titration method), and as a result, the hydroxyl value is 202 mgKOH/g.

In addition, a part of the obtained prepolymer a4 is separated by removing the solvent, and the obtained solid content is diluted to 0.1 mass % with tetrahydrofuran and subjected to GPC (Gel Permeation Chromatography), so as to measure the weight average molecular weight. As a result, the weight average molecular weight in terms of polystyrene is 15300.

### Example 1

### <Preparation of A1 Solution>

The components described below are mixed to prepare an A1 Solution.
Acrylic resin prepolymer a1: 4.57 parts
Long-chain polyol (polycaprolactone triol, PLACCEL 308, manufactured by Daicel Corporation, having a molecular weight of 850 and a hydroxyl value of 190 mgKOH/g to 200 mgKOH/g): 3.6 parts

The molar ratio [OH_{P}]/[OH_{A}] of the content [OH_{P}] of the hydroxyl group contained in the long-chain polyol to the content [OH_{A}] of the hydroxyl group contained in the acrylic resin prepolymer a1 are shown in Table 1 below.

In addition, the mass ratio [F₁]/([F₁]+[Si₂]) of the amount [F₁] of the fluorine atom and the mass ratio [Si₂]/([F₁]+[Si₂]) of the amount [Si₂] of the silicon atom in the acrylic resin prepolymer a1 are shown in Table 1 below.

### <Formation of Resin Layer A1>

The following B1 solution is added to the following A1 solution and defoamed under reduced pressure for 10 minutes. The resultant is casted on a 90 μm-thick imide film and cured at 85° C. for 1 hour and then at 130° C. for 30 minutes to obtain a resin layer A1 with a film thickness of 40 μm.
The A1 solution: 8.17 parts
B1 solution (isocyanate, DURANATE TPA 100, manufactured by Asahi Kasei Chemicals Corporation, compound name: polyisocyanurate form of hexamethylene diisocyanate): 3.8 parts

### Example 2

### <Preparation of A2 Solution>

The above components are mixed to prepare an A2 Solution.
Acrylic resin prepolymer a2: 4.13 parts
Long-chain polyol (polycaprolactone triol, PLACCEL 312, manufactured by Daicel Corporation, having a molecular weight of 1250 and a hydroxyl value of 130 mgKOH/g to 140 mgKOH/g): 4.0 parts

### <Formation of Resin Layer A2>

The following B2 solution is added to the following A2 solution and defoamed under reduced pressure for 10 minutes. The resultant is casted on a 90 μm-thick imide film and cured at 85° C. for 1 hour and then at 130° C. for 30 minutes to obtain a resin layer A2 with a film thickness of 40 μm.
The A2 solution: 8.13 parts
B2 solution (isocyanate, DURANATE TPA 100, manufactured by Asahi Kasei Chemicals Corporation, compound name: polyisocyanurate form of hexamethylene diisocyanate): 3.2 parts

### Example 3

### <Preparation of A3 Solution>

The above components are mixed to prepare an A3 Solution.
Acrylic resin prepolymer a3 (solid content of 50 mass %): 4.0 parts
Long-chain polyol (polycaprolactone triol, PLACCEL 308, manufactured by Daicel Corporation, having a molecular weight of 850 and a hydroxyl value of 190 mgKOH/g to 200 mgKOH/g): 3.5 parts

### <Formation of Resin Layer A3>

The following B3 solution is added to the following A3 solution and defoamed under reduced pressure for 10 minutes. The resultant is casted on a 90 μm-thick imide film and cured at 85° C. for 1 hour and then at 130° C. for 30 minutes to obtain a resin layer A3 with a film thickness of 40 μm.
The A3 solution: 7.5 parts
B3 solution (isocyanate, DURANATE TPA 100, manufactured by Asahi Kasei Chemicals Corporation, compound name: polyisocyanurate form of hexamethylene diisocyanate): 3.6 parts

### Example 4

### <Preparation of A4 Solution>

The above components are mixed to prepare an A4 Solution.
Acrylic resin prepolymer a4 (solid content of 50 mass %): 4.0 parts
Long-chain polyol (polycaprolactone triol, PLACCEL 308, manufactured by Daicel Corporation, having a molecular weight of 850 and a hydroxyl value of 190 mgKOH/g to 200 mgKOH/g): 5.2 parts

### <Formation of Resin Layer A4>

The following B4 solution is added to the following A4 solution and defoamed under reduced pressure for 10 minutes. The resultant is casted on a 90 μm-thick imide film and cured at 85° C. for 1 hour and then at 130° C. for 30 minutes to obtain a resin layer A4 with a film thickness of 40 μm.
The above A4 solution: 9.2 parts
B4 solution (isocyanate, DURANATE TPA 100, manufactured by Asahi Kasei Chemicals Corporation, compound name: polyisocyanurate form of hexamethylene diisocyanate): 5.2 parts

### Comparative Example 1

### <Preparation of A11 Solution>

The above components are mixed to prepare an A11 Solution.
Acrylic resin prepolymer precursor solution (solid content of 50 mass %): 4.0 parts
Long-chain polyol (polycaprolactone triol, PLACCEL 308, manufactured by Daicel Corporation, having a molecular weight of 850 and a hydroxyl value of 190 mgKOH/g to 200 mgKOH/g): 3.6 parts

### <Formation of Resin Layer A11>

The following B11 solution is added to the following A11 solution and defoamed under reduced pressure for 10 minutes. The resultant is casted on a 90 μm-thick aluminum plate and cured at 85° C. for 1 hour and then at 130° C. for 30 minutes to obtain a resin layer A11 with a film thickness of 40 μm.
The above A11 solution: 7.6 parts
B11 solution (isocyanate, DURANATE TPA 100, manufactured by Asahi Kasei Chemicals Corporation, compound name: polyisocyanurate form of hexamethylene diisocyanate): 3.8 parts

### [Evaluation on Resin Layer]

### —Return Rate and Martens Hardness at 23° C.—

The return rate and Martens hardness are measured for each of the resin layers obtained in the above Examples and Comparative Examples by the following methods. The results are shown in Table 1.

FISCHER SCOPE HM 2000 (manufactured by Fischer Instruments Co., Ltd.) is used as a measuring device, the obtained resin layer is fixed to a slide glass with an adhesive and the two are set in the above measuring device. The resin layer is loaded up to 0.5 mN for 15 seconds at room temperature (23° C.) and held at 0.5 mN for 5 seconds. The maximum displacement at this time is set to be (h1). Thereafter, the load is reduced to 0.005 mM for 15 seconds, held at 0.005 mN for 1 minute. The displacement when held at 0.005 mN for 1 minute is set to be (h2). Then the return rate “[(h1−h2)/h1]×100(%)” is calculated. From the load displacement curve during the loading, the Martens hardness is obtained.

—Contact Angles with Respect to Water and Hexadecane—

The contact angles with respect to water (water repellency) and hexadecane (oil repellency) are measured for each of the resin layers obtained in the above Examples and Comparative Examples by the following method. The results are shown in Table 1.

1 μl of water or hexadecane is dropped on the surface of the substrate with a syringe and the contact angle is measured by using a contact angle meter (model number: CA-X, manufactured by Kyowa Interface Science Co., Ltd.).

### —Dynamic Friction Coefficient for Sapphire Needle—

The friction coefficient is measured for each of the resin layers obtained in the above Examples and Comparative Examples by the following methods. The results are shown in Table 1.

A scratch needle (made of sapphire, tip radius r=0.1 mm) is reciprocated 30 mm at a speed of 10 mm/1 sec on the surface of the resin layer while applying a vertical load of 10 g to 30 g. During the reciprocating, the dynamic friction resistance in the scanning direction applied to the scratch needle is measured is using a load variation type friction wear test system, HEIDON TRIBOGEAR HHS 2000 (manufactured by Shinto Scientific Co., Ltd.) is, and the dynamic friction coefficient is calculated accordingly.

TABLE 1

| | | | | | | | Contact | Contact | |
|---|---|---|---|---|---|---|---|---|---|
| | | | | | | | angle with | angle with | |
| | Silane | | F—Si ratio % | | Martens | Return | respect to | respect to | |
| | coupling agent | Molar ratio | [F₁]/ | [Si₂]/ | Hardness | rate | water | hexadecane | Friction |
| | in A solution | [OH_{P}]/[OH_{A}] | ([F₁] + [Si₂]) | ([F₁] + [Si₂]) | [N/mm²] | [%] | [°] | [°] | coefficient |
| Example 1 | Mix | 2 | 82 | 18 | 2.8 | 93 | 105 | 52.3 | 2.1 |
| Example 2 | Mix | 1.54 | 95 | 5 | 2.9 | 92 | 105 | 53.6 | 2.2 |
| Example 3 | Polymerizied | 2 | 86 | 14 | 2.4 | 98 | 106 | 52 | 1.9 |
| | as monomer | | | | | | | | |
| | of acrylic | | | | | | | | |
| | resin | | | | | | | | |
| Example 4 | Mix | 2.5 | 0 | 100 | 2.3 | 98 | 90 | 13.9 | 2.8 |
| Comparative | No | 2 | 100 | 0 | 2.9 | 93 | 105 | 54.1 | 3 |
| Example 1 | | | | | | | | | |

As shown in Table 1, it can be seen that, in Examples formed with resin members using the A solution containing the acrylic resin having the structure in which the silane coupling agent (a) having a functional group reactive with a hydroxyl group is bonded to a side chain, or the structure in which the silane coupling agent (b) having a vinyl group is polymerized as a monomer, and the polyol having a plurality of hydroxyl groups linked by a chain having 6 or more carbon atoms, a surface protective resin member having a self-repairing property and a low friction coefficient can be obtained, compared with the Comparative Example formed with the resin member using A solution containing an acrylic resin not having any one of the structure in which the silane coupling agent (a) having a functional group reactive with a hydroxyl group is bonded to a side chain, and the structure in which the silane coupling agent (b) having a vinyl group is polymerized as a monomer.

In addition, it can be seen that in the Examples formed with resin members using a specific acrylic resin having a fluorine atom, a surface protective resin member having a self-repairing property, oil repellency and a reduced friction coefficient can be obtained.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A solution for forming a surface protective resin member, the solution comprising: an acrylic resin selected from: (i) an acrylic resin having a hydroxyl value of 40 to 280 and having a structure in which a silane coupling agent (a) having a functional group reactive with a hydroxyl group is bonded to a side chain; or (ii) an acrylic resin having a hydroxyl value of 40 to 280 and having a structure in which a silane coupling agent (b) having a vinyl group is polymerized as a monomer; and
a polyol that has a plurality of hydroxyl groups that are linked by a chain having 6 or more carbon atoms.

2. The solution for forming a surface protective resin member according to claim 1, wherein the acrylic resin has both of the structure in which the silane coupling agent (a) is bonded to the side chain and the structure in which the silane coupling agent (b) is polymerized as a monomer.

3. The solution for forming a surface protective resin member according to claim 1, wherein the acrylic resin has a fluorine atom.

4. The solution for forming a surface protective resin member according to claim 1, wherein the acrylic resin has a weight average molecular weight of 10000 to 80000.

5. The solution for forming a surface protective resin member according to claim 1, wherein a molar ratio [OH_{P}]/[OH_{A}] of a content [OH_{P}] of the hydroxyl group contained in the polyol to a content [OH_{A}] of the hydroxyl group contained in the acrylic resin is 0.1 to 10.

6. A solution set for forming a surface protective resin member, the solution set comprising:
a first solution containing the solution according to claim 1; and
a second solution containing a polyfunctional isocyanate.

7. The solution set for forming a surface protective resin member according to claim 6, wherein the acrylic resin has both of the structure in which the silane coupling agent (a) is bonded to the side chain and the structure in which the silane coupling agent (b) is polymerized as a monomer.

8. The solution set for forming a surface protective resin member according to claim 6, wherein the acrylic resin has a fluorine atom.

9. The solution set for forming a surface protective resin member according to claim 6, wherein a content ratio of the following (i) or (ii) is 0.2 mass % to 10 mass % with respect to a total amount of solid contents in the first solution and the second solution:
(i) a content ratio of the silane coupling agent (a) having a functional group reactive with a hydroxyl group in a case where the acrylic resin has only a structure in which the silane coupling agent (a) is bonded to a side chain as a structure derived from the silane coupling agent; and
(ii) a content ratio of the silane coupling agent (b) having a vinyl group in a case where the acrylic resin has only a structure in which the silane coupling agent (b) is polymerized as a monomer as a structure derived from the silane coupling agent.

10. The solution set for forming a surface protective resin member according to claim 7, wherein a content ratio of the following (iii) is 0.2 mass % to 10 mass % with respect to a total amount of solid contents in the first solution and the second solution:
(iii) a total content ratio of the silane coupling agent (a) and the silane coupling agent (b).

11. The solution set for forming a surface protective resin member according to claim 6, wherein at least one of the first solution and the second solution contains an antistatic agent.

12. The solution set for forming a surface protective resin member according to claim 6, wherein at least one of the first solution and the second solution contains a reaction accelerator for accelerating a reaction between the hydroxyl groups in the acrylic resin and the polyol and the isocyanate groups in the polyfunctional isocyanate.

13. The solution set for forming a surface protective resin member according to claim 6, wherein the acrylic resin has a weight average molecular weight of 10000 to 80000.

14. The solution set for forming a surface protective resin member according to claim 6, wherein a molar ratio [OH_{P}]/[OH_{A}] of a content [OH_{P}] of the hydroxyl group contained in the polyol to a content [OH_{A}] of the hydroxyl group contained in the acrylic resin is 0.1 to 10.

15. A surface protective resin member comprising: a cured product of:
an acrylic resin selected from: (i) an acrylic resin having a hydroxyl value of 40 to 280 and having a structure in which a silane coupling agent (a) having a functional group reactive with a hydroxyl group is bonded to a side chain, or (ii) an acrylic resin having a hydroxyl value of 40 to 280 and having a structure in which a silane coupling agent (b) having a vinyl group is polymerized as a monomer;
a polyol that has a plurality of hydroxyl groups linked by a chain having 6 or more carbon atoms; and
a polyfunctional isocyanate.

16. The surface protective resin member according to claim 15, wherein a contact angle with respect to hexadecane is 40° to 70°.

17. The solution for forming a surface protective resin member according to claim 2, wherein the acrylic resin has a fluorine atom.

18. The solution for forming a surface protective resin member according to claim 2, wherein the acrylic resin has a weight average molecular weight of 10000 to 80000.

19. The solution for forming a surface protective resin member according to claim 3, wherein the acrylic resin has a weight average molecular weight of 10000 to 80000.

20. The solution for forming a surface protective resin member according to claim 2, wherein a molar ratio [OH_{P}]/[OH_{A}] of a content [OH_{P}] of the hydroxyl group contained in the polyol to a content [OH_{A}] of the hydroxyl group contained in the acrylic resin is 0.1 to 10.
